(19) United States
(12) Patent Application Publication
(10) Pub. No.: US 2026/0312518 A1
(43) Pub. Date: Oct. 8, 2026

(54) METHOD OF IDENTIFYING THE PARAMETERS OF A PERMANENT MAGNET SYNCHRONOUS MOTOR

(71) Applicant: AROL S.P.A., Canelli (AT) (IT)

(72) Inventors: Elia BRESCIA, Canelli (AT) (IT); Giuseppe Leonardo CASCELLA, Canelli (AT) (IT); Francesco CUPERTINO, Canelli (AT) (IT); Denis RUFFINO, Canelli (AT) (IT)

(21) Appl. No.: 19/481,313

(22) PCT Filed: Apr. 30, 2024
(86) PCT No.: PCT/IB2024/054188

§ 371 Date: Nov. 4, 2025

(30) Foreign Application Priority Data
May 4, 2023 (IT) 102023000008904

(51) Int. Cl. H02P 21/14; H02P 21/16; H02P 21/18; H02P 25/022

(52) U.S. Cl. CPC H02P 21/141; H02P 21/16; H02P 21/18; H02P 25/022

(57) ABSTRACT

A method of identifying the parameters of a permanent magnet synchronous motor, especially stator winding inductances and resistances and flux generated by the rotor magnets, is provided. The method provides for compensating the non-linearity of the inverter supplying the motor with power and of the actuation delays. In the method, the steady states of the motor are identified and the operating conditions of the steady states are extracted, and the identification at least of the stator winding resistances and the flux generated by the rotor magnets uses the data of two operating conditions of different steady states, which operating conditions are selected so as to minimise estimation errors for the parameter being identified.

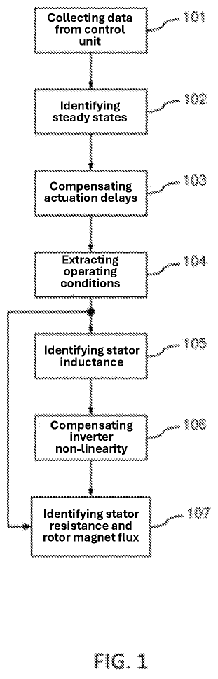

### TECHNICAL FIELD

The present invention relates to electric motors and control systems therefor, and more particularly it concerns a method of identifying the parameters of a permanent magnet synchronous motor (hereinafter also referred to with the acronym PMSM, from the English denomination ‘Permanent Magnet Synchronous Motor’), especially an isotropic motor with surface-mounted magnets.

Preferably, though not exclusively, the invention finds application in identifying parameters of motors used in capping devices for applying caps or closures to containers such as bottles and the like.

### BACKGROUND ART

Knowledge of the parameters of a permanent magnet synchronous motor, such as stator winding inductances and resistances and flux generated by the rotor magnets, is required at several stages of the motor life, e.g. design validation, control system tuning, monitoring of operating conditions and fault diagnostics. Considering that these parameters can vary considerably during the operation of the machine in which the motor is inserted, the ability to monitor their evolution over time represents a very interesting opportunity in the field of preventive and predictive maintenance and fault prevention.

Numerous methods for estimating the parameters of a PMSM are known in literature, and these can be classified into two main families: off-line methods and on-line methods.

Off-line methods are based on the a posteriori processing of data acquired through various motor tests, which are generally carried out with the motor disconnected from its machine.

In contrast, on-line methods are based on algorithms implemented in real time by the control unit of the electrical drive of the machine using the motor, and exploit the measurement data commonly available in such drives (phase currents, rotor position and rotational speed, supply voltage references fed to the inverter), which are collected and processed during ordinary operation of the motor, without disconnecting it from its machine.

While ensuring high accuracy, off-line methods have the problem of requiring the use of experienced personnel to disconnect the motor from the application in which it is used and the use of specific laboratory instrumentation, which makes them particularly costly in an industrial production environment where several motors operate in parallel on different machines. In addition, they require continuous downtime to disconnect and reconnect the motors to be tested, which is detrimental to the productivity of the plant in which the motors are used.

Known on-line methods, while exempt from the above-mentioned problems, are themselves affected by two distinct problems.

The first problem is that they can hardly be implemented from scratch on commercial drives not specifically designed for this purpose. In fact, the software of commercial drive control units is generally not modifiable to implement customized identification algorithms. Furthermore, the computational load required by on-line identification algorithms may be too much for the control unit.

The second problem is that the estimation accuracy of on-line methods is marred by the rank deficiency of the system being identified and the deficiency of measurement of the voltages actually applied to the motor.

Rank deficiency is due to the fact that the number of parameters to be identified is greater than the number of motor equations available at each step of sampling of the measured quantities (current, position, speed and voltage), which leads, among other things, to non-unambiguous parameter identification. Two different approaches have been proposed to overcome this problem.

The first approach is based on reducing the parameters to be identified, said reduction being achieved by associating part of these parameters with nameplate values or with values acquired from other estimates and measurements. However, this first approach has poor accuracy, as the variations that these parameters undergo as the operating conditions of the motor (current, speed and temperature) change are not taken into account.

The second approach, used also in the invention, is instead based on increasing the available equations. For this purpose, it was proposed to use additional data obtained by perturbing the operating point of the motor with the injection of current, voltage or position signals. An example is described in CN111030534A. Apart from the fact that signal injection in commercial drive systems is not always possible, the critical issue with this solution is its invasiveness. Indeed, signal injection can reduce the performance of the motor drive in terms of energy efficiency and control accuracy.

Regarding the problem of the lack of measurements of the voltages actually applied to the motor, on-line parametric identification algorithms generally use, as estimates of such lacking measurements, the reference supply voltages sent by the control unit to the inverter. However, because of the non-linearity of the inverter and implementation delays there is a discrepancy between actual voltages and reference voltages, and thus this procedure can give rise to non-negligible estimation errors. In principle, it has been shown that the non-linearity of the inverter can be compensated for by introducing, into the motor model equations, an additional parameter to be identified. The discrepancy caused by actuation delays increases as the ratio of the electrical speed of the motor to the frequency of the inverter pulse-width modulation increases. This is generally overlooked in the literature concerning on-line identification methods, but it can cause significant estimation errors in medium-low to high speed applications.

CN113141140A discloses a method for the on-line identification of the parameters of a PMSM with surface-mounted magnets which takes into account the problems of rank deficiency and actuation delay. The problem of rank deficiency is solved by using data acquired during a single operating condition of the motor. This known solution is inherently inaccurate because it does not include compensation for the non-linearity of the inverter. Furthermore, the use of data acquired during a single operating condition of the motor does not allow for the best possible minimisation of estimation errors.

CN108183648A discloses a method for the on-line identification of the parameters of a PMSM with compensation of the non-linearity of the inverter and actuation delays. The known method identifies the parameters by performing experimental DC tests on the motor and adopts an ad hoc electrical drive control scheme to compensate for the non-linearity of the inverter. The method is thus invasive and is rendered complex and costly by the need to design a new drive control scheme, which, moreover, must generally be adapted on a case-by-case basis.

BRESCIA ELIA ET AL: “Parameter Identification of PMSMs Considering VSI Nonlinearity with Coupled Adaline NNs”, 2023 IEEE 3RD International Conference on Power Electronics and Computer Applications (ICPECA), IEEE, 29 Jan. 2023, pages 259-265 XP034319234 discloses a method of identifying the parameters of a permanent magnet synchronous motor. Other methods are disclosed in BRESCIA ELIA ET AL: “Automated Parameter Identification of SPMSMs Based on Two Steady States Using Cloud Computing Resources” 2021 International Conference on Electrical, Computer and Energy Technologies (ICECET), IEEE, 9 Dec. 2021, pages 1-6, XP034082182, and L I FUMIN ET AL.: “Optimal FOPID Error Voltage Control Dead-Time Compensation Based on FOPI current control for PMSM Servo System”, 2023 International Conference on Fractional Differentiation and its Applications (ICFDA), IEEE, 14 Mar. 2023, pages 1-6, XP034362840.

### SUMMARY OF INVENTION

The object of the present invention is to provide a method of identifying the parameters of a permanent magnet synchronous motor that solves the problems of rank deficiency, inverter non-linearity and actuation delays and overcomes the drawbacks of prior art.

This object is achieved with a method wherein the steady states of the motor are identified and the operating conditions of said steady states, namely current, speed and temperature, of said steady states are extracted, and wherein, for identifying the at least the stator winding resistances and the flux generated by the rotor magnets, the data of two operating conditions of different steady states are used, which operating conditions are selected so as to minimise estimation errors for the parameter being identified.

Preferably, the steady state identification is performed by using the R-statistic algorithm, and the operating condition extraction includes slicing the data of each steady state into data subsets relating to time intervals in which the motor temperature is such that temperature-dependent parameters of the motor are substantially constant, the parameter identification using, for each operating condition, the data of each subset.

Advantageously, the compensation of the non-linearity of the inverter includes identifying a voltage, hereinafter referred to as distorted voltage, representative of the effects of such non-linearity, such an identification being carried out by minimising, for all samples of each operating condition of each steady state, the difference between a voltage actually applied to the motor and a reference voltage.

According to a preferred feature of the invention, the minimization of the estimation errors for the stator winding resistances and the flux generated by the rotor magnets includes minimising an error comprising a first error component due to the difference in the resistance and flux values in the two operating conditions, and a second error component due to an error in the compensation of the actuation delays by which the reference voltage is affected because of the inverter non-linearity.

Advantageously, in this case, the first error component is determined from a rough estimation of the stator winding resistances and the flux generated by the rotor magnets obtained by using predetermined values of motor temperature and rotor speed coefficients.

According to another feature of the invention, the minimisation of the estimation errors for the stator winding resistances and the flux generated by the rotor magnets includes imposing the constraints that the majorant of the estimation error is lower than a desired fraction of the respective motor parameter, and that the value of a parameter allowing evaluation of the linear independence of the equations describing a mathematical method of the motor in each of the two operating conditions selected is not close to a value denoting the lack of independence of said equations.

A further object of the invention is a capping device actuated by a permanent magnet synchronous motor and controlled by a control system, wherein said control system comprises at least one processing unit programmed for implementing the method according to the invention.

A still further object of the invention is a computer program product loaded into the memory of at least one processing unit, in particular a processing unit belonging to a control system of a device for capping containers such as bottles and the like actuated by a permanent magnet synchronous motor, the product including portions of software code for implementing the aforesaid method when the product is executed on the ate least one processing unit.

### BRIEF DESCRIPTION OF DRAWINGS

These and other features and advantages of the present invention will become evident from the following description of a preferred embodiment given by way of non-limiting example with reference to the annexed FIGURE, which shows a general flowchart of the method according to the invention.

### DESCRIPTION OF EMBODIMENTS

A method of identifying the parameters of an isotropic PMSM with surface-mounted magnets is described below. The method is based on a static mathematical model of the motor, in particular as far as the coordinates d, q are concerned. This model requires using only measurement data obtained during the steady state of the motor, i.e. in an operating condition in which both the absorbed currents and the speed are constant over time.

That being stated, the first step 101 of the method according to invention consists of collecting data from the control unit of the electrical drive of the motor. As mentioned, the data are those commonly available in PMSM control units, i.e. phase currents, rotor angular position and rotational speed, motor temperature and supply voltage references supplied to the inverter.

The collected data are used in the subsequent step 102 for identifying the steady states of the motor. To discriminate the data obtained during the steady state from the data obtained during the transient state, an algorithm known as R-statistic, applied to two different measured variables of the motor, i.e. q-axis current and mechanical speed or of the rotor. For each sample k, the algorithm assesses independently whether these two variables are in the transient state or in the steady state, by also using the former samples k-N, where N is selected by the user. The formula of the R-statistic for identifying the steady states of mechanical speed Or alone is shown below:

$${R}_{{ω}_{r}} ( k ) = 2 \frac{{Σ}_{j = k - N}^{k} {{ω}_{r , n} ( j )}^{2} = \frac{1}{N} {( {Σ}_{j = k - N}^{k} {ω}_{r , n} ( j ) )}^{2}}{{{Σ}_{i = k - N + 1}^{k} ( {ω}_{r , n} ( j ) - {ω}_{r , n} ( j - 1 ) )}^{2}} ,$$

where ω_{r,n} indicates the measured speed to which some noise has been added to improve detection performance. This algorithm is in fact designed to analyse variables affected by noise. The motor speed is considered as being in the steady state at step k if R_{ω}_{ᵣ}(k)<Rcrt, where Rcrt is an index close to 1 (typical values are 1.2-1.4) arbitrarily selected by the user with a trial-and-error method.

To facilitate understanding of the subsequent steps of the method, the equations describing the discrete time model of the motor within the reference system d, q are given below:

$${u}^{*} d ( k ) = - {L}_{q} ω ( k ) {i}_{q} ( k ) - {D}_{d} ( k ) Vdead \qquad ( 1 a )$$

$${u}^{*} q ( k ) = {Ri}_{q} ( k ) + {ψ}_{m} ω ( k ) - {D}_{q} ( k ) Vdead \qquad ( 1 b )$$

where: k indicates the k^{th} sample; u*_{d} and u*_{q} are the reference voltages of the d-axis and q-axis, respectively; i_{q} is the current of the q-axis; ω is the electrical speed of the rotor (mechanical speed multiplied by the number of polar pairs); L_{q}, R and ψₘ are the stator inductance of the q-axis, the stator resistance and the concatenated magnetic flux of the rotor, respectively; Vdead, also known as distorted voltage, is an unknown voltage that takes into account the non-linearity phenomena introduced by the inverter; and the coefficients D_{d} and D_{q}, which according to literature are obtained by studying pulse width modulation inverters, are functions of the phase currents and rotor position and can therefore be calculated from the available measurements.

According to the invention, the voltage Vdead is also identified to compensate for the non-linearity phenomena.

It should be noted that the equations do not contain the d-axis current i_{d}, because in isotropic motors this current is usually kept equal to 0 with an appropriate control action: indeed, in these motors, as is known to the person skilled in the art, the current i_{d} does not contribute to developing torque and therefore to doing useful work, but it only increases the power loss, thereby reducing the efficiency of the motor. In addition, there is only one inductance component, because in isotropic motors, under conditions of magnetic non-saturation, the inductances L_{d} and L_{q} of the two axes are the same.

After identifying the steady states, at step 103 there is effected a compensation of the actuation delay, i.e. of the fact that the control voltages of the inverter calculated by the control unit at instant k·Tₛ, where Tₛ is the sampling time of the control unit, are actually applied to the motor at instant (k+1,5) Tₛ. This delay is due to two different contributions. The first contribution is related to the digital implementation of the control algorithm and is due to the fact that the voltages calculated at a certain sampling instant are stored in memory to be then sent to the inverter at the instant of the subsequent sampling: this contribution is therefore a pure delay equal to Tₛ. The second contribution is related to the fact that the inverter receiving the voltages at step k+1 can in turn apply them to the motor after 0.5·Tₛ on average. Because of this actuation delay, in the mathematical model of the motor it is not correct to associate the voltages detected at step k with the other variables measured at the same step k, because, as mentioned, the voltages at step k are applied only after 1.5·Tₛ and therefore are not actually equal to those that will be applied after 1.5·Tₛ. In fact, the voltages at step k are calculated by taking as reference the electric position θ(k) of the rotor at said step k, but, when they are applied after 1.5·Tₛ, the rotor will have performed a rotation of about:

$$Δ θ = 1.5 \cdot {T}_{S} \cdot ω ( k ) = 15 ( θ ( k ) - θ ( k - 1 ) ) ,$$

where ω(k) is the electrical speed measure at step k. The rotation Δθ is known because both θ(k) and θ(k−1) are known.

The compensation of the actuation delay then consists of replacing the reference voltages u*d, u*q with the voltages actually applied ũ_{d}, ũ_{q}, which are given by the projections of the reference voltages on a system of orthogonal axes rotated precisely by Δθ. The assessment of the actually applied voltages ũ_{d}, ũ_{q}, can be made by using the following rotation matrix:

$${\overline{u}}_{dq} ( k ) = [ \begin{matrix}cos ( Δθ & sin ( Δθ ) \\ - sin ( Δθ ) & cos ( Δθ )\end{matrix} ] {u}_{dq}^{*} ( k - 1 ) \qquad ( 2 )$$

where ũ_{dq} and ũ*_{dq} are column vectors in which the first element is the d-axis voltage, and the other element is the q-axis voltage.

At the subsequent step 104, the operating conditions, i.e. speed, current and temperature of the motor, are extracted from the steady states. It should be noted that different operating conditions can share the same values of speed and current (i.e., they can belong to the same steady state), but will then have a certain difference in temperature Δθ. However, for the reasons set out below, the operating conditions to be actually used for identifying the stator resistance and the flux of the magnets must belong to different steady states. By using two steady states, two equation systems (1a), (1b) can be written, so that there will be four equations with four unknowns and the rank deficiency problem is solved without resorting to signal injection.

To extract the operating conditions, thermal transients must be taken into account. Indeed, the R-statistic algorithm can easily detect only quite fast transients, such as electrical or mechanical transients, and actually acts onto the current and speed of the motor to discard measurements obtained during transients of these quantities. However, the motor is also affected by thermal transients, which are much longer than the electrical and mechanical ones. In each of the steady states of the motor detected by the algorithm there can therefore be temperature variations that have considerable influence on two of the parameters to be identified (resistance and flux). This means that these two parameters vary during the same steady state if temperature changes. It is therefore appropriate to slice the data of each steady state into subsets relating to more or less uniform temperature ranges, in which the two parameters can be considered constant. The different operating conditions, uniquely identified by temperature, current and speed, are then obtained from said subsets. The data of these operating conditions are then used for identifying parameters at subsequent steps.

To take into account the slicing of the data of each steady state into data subsets, in order to carry out these subsequent steps it will be necessary to calculate the average values ũ̅, ω̅, ī_{q}, θ̅, D̅_{q} of the various variables in the different subsets, where θ is the temperature of the motor.

Once the operating conditions have been extracted, for each of them the identification of the stator inductance (step 105) is immediate, based on the relation (1a) which, not considering Vdead which is a periodic function of the period with zero mean when i_{d}=0, gives

$${L}_{qj} = - {\overline{\tilde{u}}}_{j} / {\overline{ω}}_{j} {\overline{ı}}_{q} \qquad ( 3 )$$

where j indicates the operating condition.

At this point, Vdead can be identified and therefore the non-linearity of the inverter can be compensated (step 106) by solving, for each operating condition, the minimization problem represented by the relation:

$${{min}_{{V}_{{dead}_{j}}} {\sum }_{k = \text{?}}^{\text{?}} ( {D}_{d \text{?}} ( k ) {\hat{V}}_{{dead}_{j}} + {\tilde{u}}_{\text{?}} ( k ) + {\hat{L}}_{qj} {ω}_{i} ( k ) {i}_{q \text{?}} ( k ) ) )}^{2} \qquad ( 4 )$$

$$\text{?} \text{indicates text missing or illegible when filed}$$

where i, h and j indicate the i^{th} steady state, the h^{th} subset and the j^{th} operating condition, respectively, and k_{si,h} and k_{ei,h} indicate the first sample and last sample of the subset h of the steady state I, respectively. Clearly, given relation (1a), relation (4) represents the application of the method of least squares to the difference between the actually applied voltage ũ_{d} and the reference voltage u*_{d}. It should be noted that the effectiveness of research depends on the availability of samples within a period of D_{d}Vdead, which decreases as the engine speed increases because the sampling time Tₛ is fixed.

At the subsequent step 107, identification of R and ψₘ is carried out. As mentioned, the data of two operating conditions are used for this purpose, and therefore there will be two equations (1b). The system of the two equations can be written in matrix form as:

$$[ \begin{matrix}{\overline{\tilde{u}}}_{{q}_{α}} + {\overline{D}}_{{q}_{α}} {\hat{V}}_{{dcad}_{α}} \\ {\overline{\tilde{u}}}_{{q}_{β}} + {\overline{D}}_{{q}_{β}} {\hat{V}}_{{dcad}_{β}}\end{matrix} ] = [ \begin{matrix}{\overline{i}}_{{q}_{α}} & {\hat{ω}}_{α} \\ {\overline{i}}_{{q}_{β}} & {\hat{ω}}_{β}\end{matrix} ] [ \begin{matrix}\hat{R} \\ {\hat{ψ}}_{m}\end{matrix} ] , \qquad ( 5 )$$

where the symbols \hat{ } and - above a quantity indicate the estimated value of such quantity and the mean value obtained as a result of splicing the data of each steady state into data subsets, and a and B indicate the two operating conditions that are used, which will be selected according to a criterion illustrated below. To solve the system, it is necessary that the two equations are linearly independent of each other, which involves that the determinant of the matrix of currents and speeds in the second member of the relation (5) is ≠0 and therefore the following condition is met

$$r = {i}_{q α} {ω}_{β} / {i}_{q β} {ω}_{α} \neq 1. \qquad ( 6 )$$

Meeting the condition (6) clearly requires that the operating conditions used belong to different steady states.

Under these conditions, by introducing (6) into the equation (1b) relating to each of the two operating conditions, R and Wm (or, more precisely, the estimated values thereof \hat{R} and \hat{ψ}ₘ) can be obtained according to the relations:

$$\hat{R} = \frac{- \frac{{\tilde{ω}}_{β}}{{ω}_{α}} ( {\overline{\tilde{u}}}_{{q}_{α}} + {\overline{D}}_{{q}_{α}} {\hat{V}}_{{dcad}_{α}} ) + {\overline{\tilde{u}}}_{{q}_{β}} + {\overline{D}}_{{q}_{β}} {\hat{V}}_{{dcad}_{β}}}{{\overline{i}}_{{q}_{β}} ( 1 - r )} \qquad ( 7 a )$$

$${\hat{ψ}}_{m} = \frac{{\tilde{u}}_{{q}_{α}} + {\overline{D}}_{{q}_{α}} {\hat{V}}_{{dcad}_{α}} + \frac{{\tilde{i}}_{{q}_{α}}}{{i}_{{q}_{β}}} ( {\tilde{u}}_{{q}_{β}} + {\overline{D}}_{{q}_{β}} {\hat{V}}_{{dcad}_{β}} )}{{\tilde{ω}}_{α} ( 1 - r )} \qquad ( 7 b )$$

The use of the above relations leads to estimation errors because the parameter values generally vary as the operating condition varies, and thus a different pair of resistance and flux values can be associated with each operating condition. Therefore, when parameters are to be identified in a certain operating condition a (main condition), the second operating condition B (auxiliary condition) is selected in such a way that the estimation error is minimal.

To take into account the dependency of the parameters on the operating conditions and the presence of errors in compensating the actuation delay and the non-linearity of the inverter, for each operating condition the equation (1b) can be re-written by introducing a term εᵤ_{_{q}} representative of voltage errors, thereby obtaining

$$\overline{\tilde{u}} + {\overline{D}}_{q} \hat{V} dead = R {\overline{i}}_{q} + {ψ}_{m} \overline{ω} + {ε}_{{u}_{q}} \qquad ( 8 )$$

For simplicity, only one equation has been written, omitting indication of the operating condition.

As far as resistance is concerned, by taking into account (8) and breaking down the error term into two components ε_{R} and ε_{R}_{_{M}}, which are due to the resistance value difference in the two operating conditions and the error of compensation of the q-axis voltage, respectively, the equations (7a) can be re-written as:

$$\hat{R} = {R}_{α} + {ε}_{R α} + {ε}_{{R}_{M}} \qquad ( 9 a )$$

$$\hat{R} = {R}_{β} + {ε}_{{R}_{β}} + {ε}_{{R}_{M}} , \qquad ( 9 b )$$

i.e. the values of \hat{R} are given by the actual value of R in the two operating conditions and two error terms. These in turn are given by:

$${ε}_{{R}_{α}} = \frac{{R}_{β} - {R}_{α}}{1 - r} + \frac{( {ψ}_{{m}_{β}} - {ψ}_{{m}_{α}} ) \frac{{\tilde{ω}}_{β}}{{i}_{{q}_{β}}}}{1 - r} , \qquad ( 10 )$$

$${ε}_{{R}_{β}} = \frac{( {R}_{β} - {R}_{α} ) r}{1 - r} + \frac{( {ψ}_{{m}_{β}} - {ψ}_{{m}_{α}} ) \frac{{\overline{ω}}_{β}}{{i}_{{q}_{β}}}}{1 - r} ,$$

$${ε}_{{R}_{M}} = \frac{{ε}_{{u}_{q β}} - {ε}_{{u}_{q α}} \frac{{\overline{ω}}_{β}}{{\overline{ω}}_{α}}}{{\overline{i}}_{{q}_{β}} ( 1 - r )} .$$

Similarly, the equations for the values of \hat{ψ}ₘ can be rewritten, which values will also be given by the actual value of ψₘ in the two operating conditions and the two error terms due to the difference in the concatenated flux value in the two operating conditions and the error of compensation of the q-axis voltage.

From the equations (10) and the analogous equations for \hat{ψ}ₘ it can be seen that the estimation errors depend on speed ω and current i_{q}. As mentioned, the two operating conditions are selected in such a way as to minimize the estimation error, and more precisely the error majorants. Referring to the estimation of R in the operating condition a, the error majorants are given by

$${\tilde{ε}}_{{R}_{tot}} = {\tilde{ε}}_{R} + {\tilde{ε}}_{{R}_{M}} \qquad ( 11 )$$

$${\tilde{ε}}_{{R}_{α}} = \vert \frac{{\tilde{R}}_{β} - {\tilde{R}}_{α}}{1 - r} \vert + \vert \frac{( {\tilde{ψ}}_{{m}_{β}} - {\tilde{ψ}}_{{m}_{α}} ) \frac{{\tilde{ω}}_{β}}{{i}_{{q}_{β}}}}{1 - r} \vert , \qquad ( 12 )$$

$${\tilde{ε}}_{{R}_{M}} = \frac{\vert {\tilde{ε}}_{{u}_{q}} \vert + \vert {\tilde{ε}}_{{u}_{q}} \frac{{\overline{ω}}_{β}}{{\overline{ω}}_{α}} \vert}{\vert {\overline{i}}_{{q}_{β}} ( 1 - r ) \vert} ,$$

where \tilde{ε}_{R}, \tilde{ε}_{R}_{_{M}} are the values of the aforementioned error components, which values are obtained by using approximate estimates \hat{R}ᵢ, \hat{ψ}ₘᵢ (i=α, β) of R and ψₘ. These are calculated by using only temperature and speed data according to the relations

$${\overline{R}}_{i} = {\tilde{R}}_{0} ( 1 + {α}_{0} ( {\tilde{Θ}}_{i} - 20 ) ) ( 1 + {{\tilde{β}}_{0} ( \frac{{\overline{ω}}_{k}}{2 π} )}^{2} ) , \qquad ( 13 )$$

$${\tilde{ψ}}_{{m}_{k}} = {\tilde{ψ}}_{α} ( 1 + {\tilde{α}}_{PM 0} ( {\overline{Θ}}_{i} - 20 ) ) ,$$

where \tilde{R}₀ and \tilde{ψ}0 indicate the approximate estimates of R and ψₘ at speed 0 and temperature 20° C., α₀ is the temperature coefficient of copper resistivity, \tilde{β}₀ is the assumed quadratic frequency coefficient and \tilde{α}_{PM0} is the assumed temperature coefficient of the permanent magnets. The use of precautionary values for \tilde{ε}ᵤ_{_{q}}, \tilde{β}₀ and \tilde{α}_{PM0} ensures that \tilde{ε}_{R}_{ₜₒₜ}>\tilde{ε}_{R}+\tilde{ε}_{R}_{_{M}}.

To obtain \tilde{R}₀, the operating conditions α, β are selected as follows:

$$[ α , β ] = {arg min}_{\begin{matrix}i , j = 1 , … , {N}_{OC} \\ i \neq j\end{matrix}} \frac{\vert {\tilde{ε}}_{{u}_{q}} \vert + \vert {\tilde{ε}}_{{u}_{q}} \frac{{\overline{ω}}_{j}}{{\overline{ω}}_{i}} \vert}{\vert {i}_{{q}_{j}} ( 1 - \frac{{i}_{{q}_{i}} {\overline{ω}}_{j}}{{i}_{{q}_{j}} {\overline{ω}}_{i}} ) \vert} \qquad ( 14 )$$

with the constraints:

$$\vert ω i \vert / 2 π < {f}_{li m} e \vert \frac{{\overline{i}}_{{q}_{i}} {\overline{ω}}_{j}}{{\overline{i}}_{{q}_{j}} {\overline{ω}}_{i}} \vert > {r}_{l i m}$$

where fₗᵢₘ and [symbol] are positive adjustment parameters. The relation (14) originates from the fact that \tilde{R}₀ is calculated by correcting the estimate \hat{R}_{α} of the resistance in the condition α. Therefore, it is convenient to find the condition a in such a way that the values \hat{R}_{α} and \tilde{R}_{α} are close to each other, i.e. in such a way that temperature and speed in the equations (13) are close to 20° C. and 0, respectively. The temperature correction can be obtained easily, because α₀ does not depend on the motor used, but this does not apply to the frequency correction, because \tilde{β}₀ depends on the motor. To avoid adding precautionary factors to the relation (14), one only makes ω̆_{α} close to 0 (first constraint for the relation (14)). In addition, errors ER, and ERM have to be minimised. The first of these two errors cannot be explicitly minimised, because the estimates of the parameters are unknown, but it can be made small by selecting the two operating conditions in such a way that |1−r| in the first of the equations (12) is large (second constraint for the relation (14)). Instead, \tilde{ε}_{R}_{_{M}} is minimized by considering it as a target function. Once the conditions a, B are selected according to the relation (14), \hat{R}_{α} is calculated according to the relation (7a). Finally, a temperature and frequency correction gives \tilde{R}₀:

$${\tilde{R}}_{0} = \frac{{\hat{R}}_{α}}{( 1 + {α}_{0} ( {\tilde{Θ}}_{α} - 20 ) ) ( 1 + {{β}_{0} ( \frac{{\overline{ω}}_{α}}{2 π} )}^{2} )} . \qquad ( 15 )$$

With similar considerations, to obtain \tilde{ψ}₀ the operating conditions α, β are selected as follows:

$$[ α , β ] = {arg min}_{{i , j = 1 , … , {N}_{OC}}_{i \neq j}} \frac{\vert {\tilde{ε}}_{{u}_{q}} \vert + \vert {\tilde{ε}}_{{u}_{q}} \frac{{i}_{{q}_{i}}}{{i}_{{q}_{j}}} \vert}{\vert {\overline{ω}}_{i} ( 1 - \frac{{i}_{{q}_{i}} {\overline{ω}}_{j}}{{i}_{{q}_{j}} {\overline{ω}}_{i}} ) \vert} \qquad ( 16 )$$

with the constraints:

$$\vert {\overline{Θ}}_{i} - 20 \vert < {Θ}_{l i m} e \vert \frac{{\overline{i}}_{{q}_{i}} {\overline{ω}}_{j}}{{\overline{i}}_{{q}_{j}} {\overline{ω}}_{i}} \vert > {r}_{l im}$$

where ↓ₗᵢₘ is an adjustment parameter. N_{oc} is the total number of operating conditions. Once the conditions α, β are selected according to the relation (16), \hat{ψ}_{mβ} is calculated according to the relation (7b). Finally, a temperature and frequency correction gives \tilde{ψ}₀:

$${\tilde{ψ}}_{0} = \frac{{\hat{ψ}}_{{m}_{β}}}{1 + {\tilde{α}}_{PM 0} ( {\tilde{Θ}}_{β} - 20 )} . \qquad ( 17 )$$

The majorant of the error of estimation of the concatenated flux of the rotor in the operating condition β can in turn be calculated with the procedure described for the stator resistance.

Once the approximate estimates have been obtained, error majorants can be calculated and explicitly minimised. Regarding the resistance R, given a main operating condition a for which this has to be determined, the auxiliary condition β will be selected in such a way as to minimize \tilde{ε}_{R}_{_{αtot}}, namely

$$β = {arg min}_{\begin{matrix}i = 1 , … , {N}_{OC} \\ i \neq j\end{matrix}} {\tilde{ε}}_{{R}_{α} tot} \qquad ( 18 )$$

with the constraints r<εᵣ₁ or r>εᵣ₂ and \tilde{ε}_{Rj}_{ₜₒₜ}<x_{R}\tilde{R}_{α}, where:
εᵣ₁ and εᵣ₂ are constants that are arbitrarily selected on a case-by-case basis, the first constant being less than 1 and the second constant being more than 1, which avoid selecting r too close to 1 and thus effectively guarantee the linear independence of the two equations describing the model under the two operating conditions;
xR instead is a parameter that is also arbitrarily selected on a case-by-case basis and has a value between 0 and 1, which requires that the error majorant be less than a given fraction of the approximate estimate of Rα.

The foregoing constraints, too, are met only in the case of operating conditions belonging to different steady states.

An estimate in the main operating condition may be rejected if there is no such auxiliary operating condition that the error majorant \tilde{ε}_{R}_{ₜₒₜ} is smaller than the given fraction of \tilde{R}_{α}.

Once the auxiliary condition B has been found, actual identification is obtained with the equation (7a).

A similar procedure will lead to the identification of ψₘ.

The invention effectively overcomes the drawbacks of prior art. In fact, it offers a totally non-invasive method that requires neither experimental testing nor designing a new drive control scheme, but is based solely on the analysis of data generated by a standard drive during normal operation of the motor. Moreover, using the data of two operating conditions for identification allows finding parameter values that actually ensure minimisation of the estimation error.

Furthermore, it is clear from the foregoing description that the invention does not use the nameplate values of the parameters. First of all, this ensures greater applicability of the method. In fact, in industrial plants where motors of different sizes and different manufacturers are involved, it is not trivial to have data sheets available for all the types of motors present. This also makes the method more robust. In fact, the nameplate values are referred to measurements effected at the beginning of the lifecycle of the motor and in predetermined environmental and operating conditions, which will generally differ from the actual conditions of the application in which the motor operates. In addition, because of the wear of various components of the PMSM, the parameters will vary over time.

It is apparent that the above description has been given solely as a non-limiting example and that variations and modifications are possible without departing from the scope of protection of the invention as defined in the appended claims.

1. A method of identifying the parameters of a permanent magnet synchronous motor, more particularly stator winding inductances and resistances and flux generated by the rotor magnets, the method providing for compensating the non-linearity of the inverter supplying the motor with power and of the actuation delays, characterised in that the steady states of the motor are identified (102) and the operating conditions, namely current, speed and temperature, of said steady states are extracted (104), and in that, for identifying the parameters, the data of two operating conditions of different steady states are used, which operating conditions are selected so as to minimise estimation errors for the parameter being identified.

2. The method according to claim 1, wherein the steady state identification (102) is performed by using the R-statistic algorithm, and the operating condition extraction (104) includes slicing the data of each steady state into data subsets relating to time intervals in which the motor temperature is such that temperature-dependent parameters of the motor are substantially constant, the parameter identification using, for each operating condition, the data of each of said subsets.

3. The method according to claim 2, wherein the compensation of the non-linearity of the inverter (106) includes identifying a voltage representative of the effects of such non-linearity, such an identification being carried out by minimising, for all samples of each operating condition of each steady state, the difference between a voltage actually applied to the motor and a reference voltage.

4. The method according to claim 1, wherein the minimisation of the estimation errors for the stator winding resistances and the flux generated by the rotor magnets includes minimising an error comprising a first error component due to the difference in the resistance and flux values in the two operating conditions, and a second error component due to an error in the compensation of the actuation delays by which the reference voltage is affected because of the inverter non-linearity.

5. The method according to claim 4, wherein the first error component is determined from a rough estimation of the stator winding resistances and the flux generated by the rotor magnets obtained by using predetermined values of motor temperature and rotor speed coefficients.

6. The method according to claim 1, wherein the minimisation of the estimation errors for the stator winding resistances and the flux generated by the rotor magnets includes imposing the constraints that the majorant of the estimation error is lower than a desired fraction of the respective motor parameter, and that the value of a parameter which allows evaluation of the linear independence of the two equations describing a mathematical method of the motor in the two operating conditions selected and is linked to current and speed in the two conditions is not close to a unitary value denoting the lack of independence of said equations.

7. The method according to claim 1, for identifying the parameters of a permanent magnet synchronous motor employed in a device for capping containers.

8. A capping device actuated by a permanent magnet synchronous motor and controlled by a control system, characterised in that said control system comprises at least one processing unit programmed for implementing the method according to claim 1.

9. A computer program product loaded into the memory of a processing unit, in particular a processing unit belonging to a control system of a device for capping containers such as bottles and the like actuated by a permanent magnet synchronous motor, the product including portions of software code for implementing the method according to claim 1 when the product is executed on the processing unit.
